(19) United States
(12) Patent Application Publication
(10) Pub. No.: US 2023/0034789 A1
(43) Pub. Date: Feb. 2, 2023

(54) COLLAPSIBLE DRIP COVER FOR SLIDING FENESTRATION UNIT

(71) Applicant: JELD-WEN, Inc., Charlotte, NC (US)

(72) Inventors: David Lee YAGLA, Klamath Falls, OR (US); Philip Steven PERKINS, Klamath Falls, OR (US); Derek Lee KINDT, Klamath Falls, OR (US); Shane Michael MEYER, Klamath Falls, OR (US)

(73) Assignee: JELD-WEN, Inc., Charlotte, NC (US)

(21) Appl. No.: 17/443,537

(22) Filed: Jul. 27, 2021

(51) Int. Cl. E06B 7/14; E06B 1/62

(52) U.S. Cl. CPC E06B 7/14; E06B 1/62; E06B 1/702

(57) ABSTRACT

A drip cover for a fenestration unit. The fenestration unit includes a frame and a slideable panel supported for sliding movement within the frame. A gap is defined between the slideable panel and the frame. The drip cover includes a mounting member configured to attach to the slideable panel. The drip cover also includes an overhang that projects from the mounting member and that is configured to cover over the gap when the mounting member is attached to the slideable panel. The overhang is supported for resilient flexure relative to the mounting member between a neutral position and a flexed position. The overhang is resiliently biased toward the neutral position. The overhang, when the mounting member is attached to the slideable panel, is configured to contact a surface, thereby resiliently flexing the overhang between the neutral position and the flexed position, as the slideable panel slides relative to the surface.

### TECHNICAL FIELD

The present disclosure generally relates to a fenestration unit and, more particularly, relates to a collapsible drip cover for a sliding fenestration unit.

### BACKGROUND

Fenestration units, such as horizontally sliding doors and windows, may include features for managing rainwater, snow runoff, sleet, water from nearby sprinkler systems, and/or other moisture. These features may help divert water and/or channel water away in a predetermined manner to be directed away from the fenestration unit.

However, several challenges remain in this regard. For example, some of these features may fail when subjected to extreme conditions and allow for undesirable water intrusion. Also, these water management features may be difficult to incorporate for fenestration units with an active or movable panel (e.g., a sliding door or window). Some features may limit movement of the active panel within the frame and/or may increase the operating force necessary for movement of the panel. Furthermore, some water diversion features may be bulky or visually unappealing. Furthermore, these features may present manufacturing difficulties, for example, by increasing part count, by increasing assembly time, by decreasing manufacturability, etc.

Thus, it is desirable to provide improved water management features for a fenestration unit, including features that provide more robust water diversion and other weather resistance. It is also desirable to incorporate such features without significantly limiting movement of an active panel within its frame. Likewise, it is desirable to provide such water diversion features in a fenestration unit with a moveable panel without increasing necessary operating forces for moving the panel. Furthermore, it is desirable to provide weather management features that provide increased manufacturing efficiencies. Other desirable features and characteristics of the present disclosure will become apparent from the subsequent detailed description and the appended claims, taken in conjunction with the accompanying drawings and this background discussion.

### BRIEF SUMMARY

In one embodiment, a drip cover for a fenestration unit is disclosed. The fenestration unit includes a frame and a slideable panel that is supported for sliding movement within the frame and relative to a surface of the fenestration unit. A gap is defined between the slideable panel and the frame. The drip cover includes a mounting member configured to attach to the slideable panel. The drip cover also includes an overhang that projects from the mounting member and that is configured to cover over the gap when the mounting member is attached to the slideable panel. The overhang is supported for resilient flexure relative to the mounting member between a neutral position and a flexed position. The overhang is resiliently biased toward the neutral position. The overhang, when the mounting member is attached to the slideable panel, is configured to contact the surface, thereby resiliently flexing the overhang between the neutral position and the flexed position, as the slideable panel slides relative to the surface.

In another embodiment, a method of manufacturing a drip cover for a fenestration unit is disclosed. The fenestration unit includes a frame and a slideable panel that is supported for sliding movement within the frame and relative to a surface of the fenestration unit. A gap is defined between the slideable panel and the frame. The method includes forming a mounting member configured to attach to the slideable panel. The method also includes forming an overhang that projects from the mounting member and that is configured to cover over the gap when the mounting member is attached to the slideable panel. The overhang is supported for resilient flexure relative to the mounting member between a neutral position and a flexed position, and the overhang is resiliently biased toward the neutral position. Furthermore, the overhang, when the mounting member is attached to the slideable panel, is configured to contact the surface, thereby resiliently flexing the overhang between the neutral position and the flexed position, as the slideable panel slides relative to the surface.

In an additional embodiment, a fenestration unit is disclosed, which includes a frame and a panel supported for sliding movement within the frame relative to an engagement surface of the fenestration unit. Also, a gap is defined between the panel and the frame. Furthermore, the fenestration unit includes a drip cover that has a mounting member that is attached to the panel and that includes an overhang that projects from the mounting member to cover over the gap. The drip cover includes a resiliently flexible pivot joint that attaches the overhang to the mounting member and that supports rotation of the overhang relative to the mounting member between a neutral position and a flexed position. The overhang is resiliently biased toward the neutral position. The overhang is configured to engage the engagement surface of the fenestration unit, thereby resiliently flexing the overhang between the neutral position and the flexed position, as the panel slides relative to the engagement surface of the fenestration unit.

### BRIEF DESCRIPTION OF THE DRAWINGS

The present disclosure will hereinafter be described in conjunction with the following drawing figures, wherein like numerals denote like elements, and wherein:

FIG. 1 is a section view of a fenestration unit and a drip cover attached thereto according to example embodiments of the present disclosure;

FIG. 2 is an end view of the drip cover of FIG. 1;

FIG. 3 is an isometric view of the drip cover of FIG. 1;

FIG. 4 is an isometric view of the drip cover shown in a plurality of positions on a panel of the fenestration unit according to example embodiments of the present disclosure; and

FIG. 5 is a schematic view of a method of manufacturing the drip cover of FIG. 1 according to example embodiments of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

Broadly, example embodiments disclosed herein include a drip cover for a fenestration unit, such as a horizontally sliding door or window. The drip cover may include a mounting member and an overhanging portion (i.e., an overhang) that projects and extends from the mounting member. The drip cover may also, in some embodiments, include a flexible joint that moveably couples the mounting member and the overhang. In some embodiments, the joint supports the overhang outward and downward when the drip cover is mounted on a panel of the fenestration unit such that the overhang covers over a gap between a panel of the fenestration unit and a frame thereof.

The drip cover may be attached to an active panel (e.g., a sliding door or window) of the fenestration unit. Thus, the drip cover may slide as a unit with the active panel. The drip cover may include one or more features that facilitate and enable such movement of the active panel while still providing water protection.

For example, the joint of the drip cover may resiliently and elastically flex, allowing the overhang to move (e.g., pivot, fold and unfold, rotate, etc.) relative to the mounting member of the drip cover. Accordingly, in some embodiments, the active panel may move between a closed position and an open position relative to a surface of the fenestration. More specifically, the active panel may move to an open position so as to be overlapped with another panel (e.g., a fixed panel) of the fenestration unit. The drip cover may resiliently flex away from a neutral position toward a flexed position as the active panel moves relative to the other. In some embodiments, as the active panel moves, the drip cover may engage the other panel, thereby resiliently flexing the drip cover. As such, the drip cover may fold under the other panel as the active panel moves. Then, as the active panel is moved in the opposite direction (e.g., toward the closed position), the drip cover may disengage the other panel, and may resiliently recover back toward its neutral position. As the drip cover flexes and as the active panel moves, the overhang of the drip cover may remain positioned such that water is diverted away from predetermined areas, such as a gap between the active panel and the frame.

Furthermore, the drip cover may include features that improve function of the fenestration unit. For example, the drip cover may include at least one longitudinal end that is configured to progressively engage an opposing surface of the fenestration unit as the active panel moves within its frame. The longitudinal end may progressively engage a stationary surface of the frame of the fenestration unit, may engage the other panel (e.g., a stationary panel), etc. Accordingly, as the active panel moves behind the other panel, the longitudinal end of the drip cover may engage the opposing surface, thereby causing flexure of the drip cover. This “leading end” of the drip cover may be shaped, positioned, oriented, and/or otherwise configured to progressively engage the other panel as the active panel moves for reliably flexing the drip cover behind the other panel. Furthermore, the drip cover may include an exterior edge that may run and slideably engage the other panel as the active panel moves behind the other panel. This “running edge” of the drip cover may slide smoothly along the other panel without significantly impeding movement of the active panel. The resilience of the drip cover may bias this edge of the drip cover against the other panel as the active panel moves relative thereto. Furthermore, this edge of the drip cover may be shaped, positioned, oriented, or otherwise configured to engage the other panel, to divert water, and/or to facilitate movement of the active panel.

Accordingly, the drip cover may include a number of features that provide highly robust weather resistance without impeding movement of the active panel of a fenestration unit. These features may be incorporated without significantly increasing necessary operating forces for moving the panel. Furthermore, one or more features of the present disclosure may provide manufacturing benefits, such as lower part count, increased manufacturing efficiency, and/or other advantages.

Referring to the Figures, a drip cover 102 for a fenestration unit 104 is shown according to example embodiments of the present disclosure. The drip cover 102 may be supported on one of a plurality of panels of the fenestration unit 104 and may direct water, droplets of water, rainwater, sleet and snow runoff, water from sprinkler systems, and/or other moisture in a predetermined manner. The drip cover 102 may cover over specific areas of the fenestration unit 104, for example, to limit water intrusion towards the interior of the structure and/or to direct moisture toward the exterior of the structure.

In some embodiments, the fenestration unit 104 may be a sliding door, and the majority of the discussion will refer to the fenestration unit 104 as such as an example. However, it will be appreciated that the drip cover 102 may be configured for a horizontally-sliding window or another type of fenestration unit 104 without departing from the scope of the present disclosure.

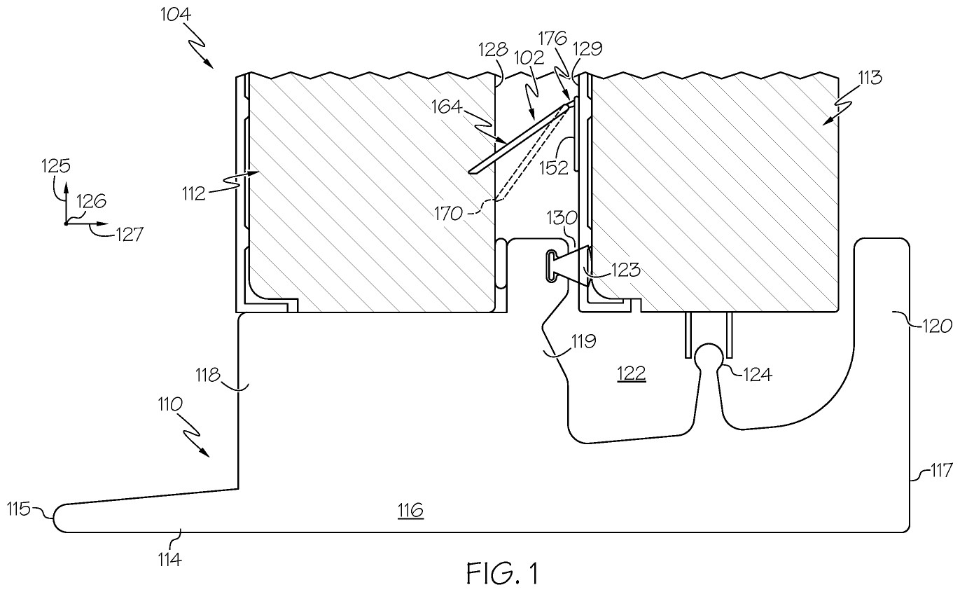

As shown in FIG. 1, the fenestration unit 104 may include a frame 110 that supports a first panel 112 and a second panel 113. At least one of the panels 112, 113 may be a sliding panel that is supported within the frame 110 for sliding movement along a longitudinal axis 126. In some embodiments, the first panel 112 may be a fixed, non-active panel that is fixedly supported within the frame 110, whereas the second panel 113 may be a horizontally sliding panel that is supported for sliding movement along the axis 126. A vertical axis 125 is included in FIG. 1 for reference purposes.

Although the panels 112, 113 are schematically illustrated, it will be appreciated that the panels 112, 113 may include a number of components, such as a bottom rail that supports a glass or other glazing unit and/or other components. The panels 112, 113 may be supported within the frame 110 and may be offset laterally (horizontally and normal to the longitudinal axis 126) along a lateral axis 127. Accordingly, in some embodiments, the second panel 113 may move along the axis 126 relative to the first panel 112, for example, between an open position in which the panels 112, 113 are overlapping along the lateral axis 127, and a closed position in which the panels 112, 113 are non-overlapping and are spaced apart along the axis 126.

The frame 110 may include a sill 114, the cross-section of which is represented schematically in FIG. 1. The sill 114 may be an elongate support structure that extends along the longitudinal axis 126. The sill 114 is represented largely as a one-piece, unitary structure in FIG. 1. However, it will be understood that the sill 114 may include an assembly of parts. For example, in some embodiments, the sill 114 may be an assembly of extruded, elongate parts that collectively define the sill 114 and that collectively support the panels 112, 113.

The sill 114 may include a base 116 that is generally wedge-shaped in cross-section (FIG. 1) and that defines an exterior side 115 and an interior side 117 of the fenestration unit 104. Upon the base 116, the sill 114 may include an exterior stand 118. The exterior stand 118 may define a step-like support that is proximate the exterior side 115 and that supports the first panel 112 of the fenestration unit 104.

The sill 114 may also include an interior upstand 120. The interior upstand 120 may be substantially rectangular in cross-section with one elongate edge attached to the base 116 and the other edge projecting from the interior side 117 of the base 116 in an upward, vertical direction (opposite the direction of gravity).

Furthermore, the sill 114 may include an intermediate upstand 119. The intermediate upstand 119 may have a generally rectangular cross-section and may project upward from the base 116. The intermediate upstand 119 may extend longitudinally along the axis 126. The intermediate upstand 119 may be disposed laterally between the stand 118 and the interior upstand 120. The intermediate upstand 119 may be received within an interior-facing surface 128 of the first panel 112 and an exterior-facing surface 129 of the second panel 113.

Also, an elongate channel 122 may be defined between the intermediate upstand 119 and the interior upstand 120, and the base 116 may substantially close off the bottom side of the channel 122. The frame 110 may further include a rail 124 within the channel 122 that projects upward vertically from the base 116.

The second panel 113 may be supported for movement within the channel 122. The rail 124 may support this sliding movement of the second panel 113 of the fenestration unit 104 along the axis 126.

As shown in FIG. 1, there may be a thin, elongate gap 130 defined between the exterior-facing surface 129 of the second panel 113 and the intermediate upstand 119. The gap 130 may be substantially filled and blocked by a weather seal 123, which substantially reduces and limits water intrusion through the gap 130 into the channel 122.

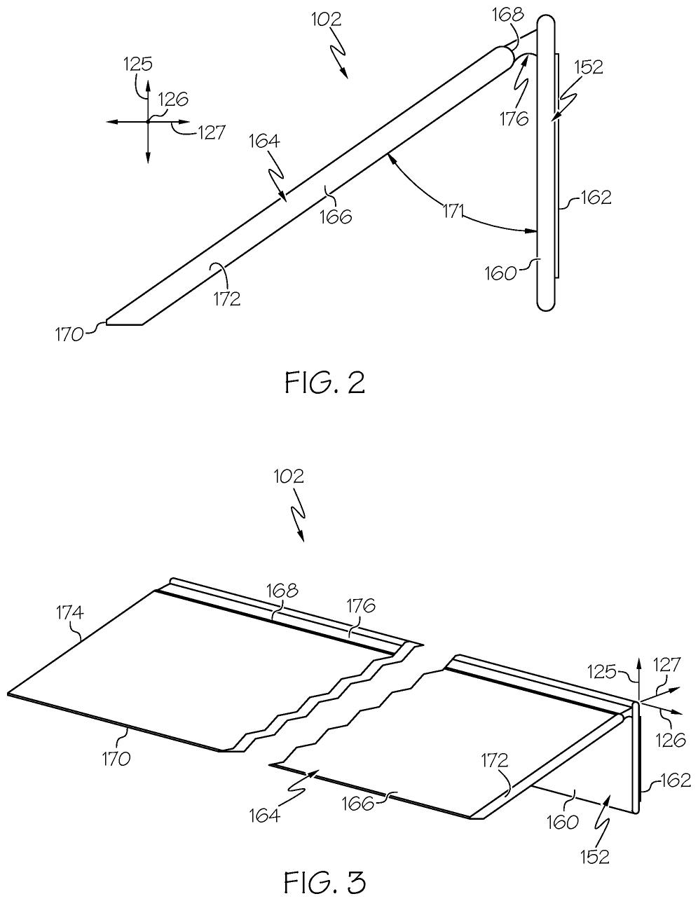

The drip cover 102 may provide additional water resistance for the fenestration unit 104 and may cover over the gap 130 as shown in FIG. 1 and as will be discussed. The drip cover 102 is shown in isolation in FIGS. 2 and 3 according to example embodiments of the present disclosure.

As shown in FIGS. 2 and 3, the drip cover 102 may generally include a mounting member 152. The mounting member 152 may include an elongate, substantially flat and planar strip 160. The strip 160 may extend along the longitudinal axis 126 and may have any suitable length. The strip 160 may be somewhat rigid, but lightweight. In some embodiments, the mounting member 152 may further include an adhesive 162 included on a back surface of the strip 160. The adhesive 162 may be a double-sided tape, an applied adhesive layer, or other application of adhesive 162. The mounting member 152 may be configured to attach to the second panel 113. For example, the adhesive 162 may be used to adhesively attach the strip 160 the panel 113. The strip 160 may be layered over the substantially vertical surface 129 of the second panel 113, in close proximity over the gap 130.

It will be appreciated that the mounting member 152 may be attached to the second panel 113 according to additional embodiments. For example, the strip 160 may be fixed to the second panel 113 using fasteners (e.g., screws) without departing from the scope of the present disclosure.

The drip cover 102 may further include an overhang 164. The overhang 164 may include an elongate, substantially flat and planar strip 166. The strip 166 may extend along the longitudinal axis 126 and may have a length that is proportionate to the strip 160 of the mounting member 152. The strip 166 may be somewhat rigid, but lightweight. In some embodiments, the strip 166 and the strip 160 of the mounting member 152 may be made from the same material. For example, in some embodiments, the strips 160, 166 may be formed from chlorinated polyvinyl chloride (CPVC). Accordingly, the strips 160, 166 may be resistant to thermal expansion, may resist UV discoloration, may be extrudable, and/or may provide other benefits.

The strip 166 of the overhang 164 may include a first longitudinal edge 168 (a connected edge), which is connected and/or coupled to the mounting member 152. The strip 166 may be cantilevered to the mounting member 152 at the first longitudinal edge 168. The strip 166 may also include a second longitudinal edge 170. The overhang 164 may be supported with the second longitudinal edge 170 of the strip 166 projected laterally away and in a downward vertical direction from the strip 160 of the mounting member 152. In other words, in some embodiments, the strip 166 of the overhang 164 may project outward from the strip 160 of the mounting member 152 and may be canted downward from horizontal (i.e., from the plane defined by the longitudinal and transverse axes 126, 127). As such, an acute angle 171 may be defined between the strip 160 of the mounting member 152 (i.e., the vertical axis 125) and the overhang 164. In some embodiments, the thickness of the strip 166 may remain substantially constant between the first edge 168 and the second edge 170. However, as shown in FIG. 2, the second edge 170 may be tapered. More specifically, the second edge 170 may be wedge-shaped and may taper to a point at the second edge 170.

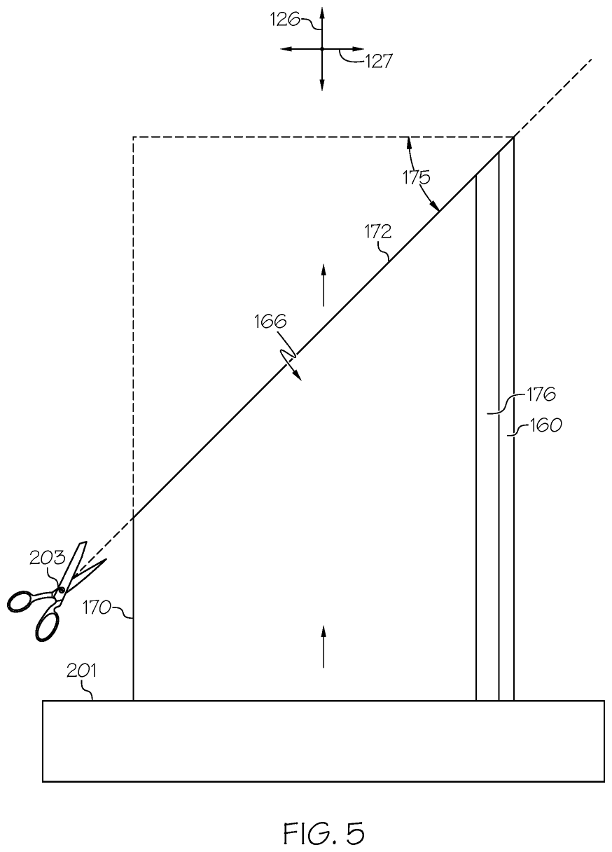

Furthermore, as shown in FIG. 3, the strip 166 may include a first longitudinal end 172 and a second longitudinal end 174. The first and second longitudinal ends 172, 174 may be spaced apart along the longitudinal axis 126. The first longitudinal end 172 and/or the second longitudinal end 174 may be disposed at a bias angle 175 (FIG. 5) relative to the transverse axis 127. In some embodiments, the first longitudinal end 172 may be a straight edge of the strip 166 that extends along a line that intersects the plane defined by the vertical and transverse axes 125, 127. As such, the first longitudinal end 172 may be disposed at the bias angle 175 relative to the plane defined by the vertical and transverse axes 125, 127.

The drip cover 102 may additionally include a pivotable joint 176. The pivotable joint 176 may pivotably couple the mounting member 152 and the overhang 164. The pivotable joint 176 may be a bead, web, or other elongate strip that extends continuously along the longitudinal axis 126 and continuously between the mounting member 152 and the overhang 164 along the lateral axis 127. The joint 176 may be more flexible than both the mounting member 152 and the overhang 164. In some embodiments, the pivotable joint 176 may be made of material that is more flexible (i.e., lower modulus of elasticity) than the material of the mounting member 152 and/or the material of the overhang 164. For example, in some embodiments, the pivotable joint 176 may be made of thermoplastic elastomer, which is based on a partially cross-linked, chlorinated olefin interpolymer alloy. In contrast, both the strip 160 of the mounting member 152 and the strip 166 may be made of CPVC as noted above.

The thickness of the pivotable joint 176 may also vary slightly as the joint 176 extends laterally between the overhang 164 and the mounting member 152. The joint 176 may be thinnest approximately at its lateral midpoint (between the overhang 164 and the mounting member 152) to thereby enhance flexibility of the joint 176. The pivotable joint 176 may, in some embodiments, be and/or define a so-called “living hinge” of the drip cover 102.

Furthermore, in some embodiments, the pivotable joint 176 may be integrally connected to the strip 160 and the strip 166. For example, the joint 176 may be co-extruded with the strips 160, 166 such that the drip cover 102 is largely a unitary, one-piece part.

The pivotable joint 176 may rotatably support the overhang 164 for resilient flexure relative to the mounting member 152 between a neutral position (shown in solid lines in FIG. 1) and a flexed position (shown in phantom lines in FIG. 1). The angle 171 may vary as the overhang 164 moves relative to the mounting member 152. The overhang 164 may rotate about the joint 176 and fold toward the mounting member 152 as the drip cover 102 flexes from the neutral position toward the flexed position, thereby reducing the angle 171. In contrast, the overhang 164 may rotate away from the mounting member 152, unfold, and increase the angle 171 as the drip cover 102 biases back toward the neutral position. The pivotable joint 176 may be robust to support this cyclical flexure and recovery over a long operating lifetime.

The drip cover 102 may be supported on the second panel 113 (i.e., the active panel). The mounting member 152 may be adhesively or otherwise attached to the exterior-facing surface 129 of the second panel 113. As such, the overhang 165 may project outward and away from the second panel 113 and from the mounting member 152. As shown in FIG. 1, the overhang 165 may be cantilevered over the gap 130.

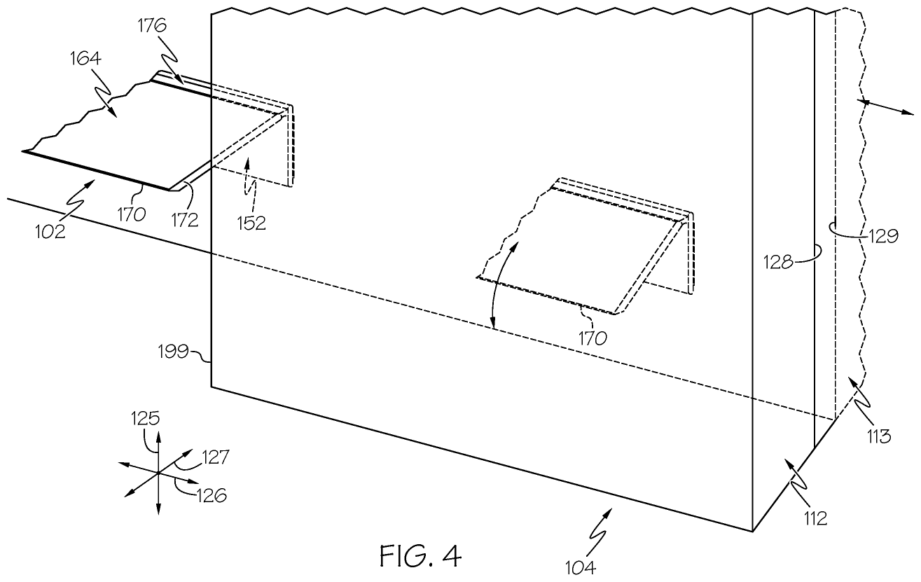

As shown in FIG. 4, the second panel 113 may slide along the axis 126 between a closed position (shown with solid lines) and an open position (shown in phantom) relative to the first panel 112. In the open position, the second panel 113 may be overlapped with the first panel 112 along the transverse axis 127. In contrast, the first and second panels 112, 113 may be largely spaced apart along the axis 126 when the second panel 113 is in the closed position.

The drip cover 102 may be in the neutral position when the second panel 113 is in the closed position, as shown in solid lines in FIG. 4. As the second panel 113 slides along the axis 126 toward the open position, the first longitudinal end 172 may engage and slide progressively on an opposing face 199 of the first panel 112 to thereby rotatably and resiliently flex the overhang 164 toward the mounting member 152 via the joint 176. As shown in FIG. 4, the face 199 may be a vertical surface of the first panel 112 facing normal to the axis 126. In additional embodiments, the face 199 may, instead, be included on a stile of the frame 110 or another engagement surface of the fenestration unit 104.

As such, the drip cover 102 may fold under the first panel 112 as the second panel 113 moves toward the open position as represented in phantom in FIG. 4. The outer second edge 170 may slide along and remain engaged against the interior-facing surface 128 of the first panel 112. Then, as the second panel 113 slides in the opposite direction toward the closed position, the drip cover 102 may disengage the first panel 112 and may resiliently recover back toward its neutral position. As the drip cover 102 flexes and as the second panel 113 moves, the overhang 164 of the drip cover 102 may remain covering the gap 130 as shown in FIG. 1.

Accordingly, the drip cover 102 may robustly protect against water intrusion via the gap 130. The drip cover 102 is unlikely to impede movement of the second panel 113. Additionally, the second panel 113 may be moved at low operating forces that are unlikely to be increased by the drip cover 102.

Those having ordinary skill in the art will appreciate that additional embodiments fall within the scope of the present disclosure. In additional embodiments, the drip cover 102 may have the neutral and flexed positions as mentioned above. However, the drip cover 102 may be at least partially flexed and folded under, when the second panel 113 is in the closed position relative to the first panel 112. For example, with the second panel 113 in the closed position, the first longitudinal end 172 and/or a portion of the outer second edge 170 may abut against the first panel 112 and/or the frame 110, which thereby flexes the abutting portion of the drip cover 102 downward. Meanwhile, the second longitudinal end 174 may be spaced apart axially from the first panel 112 and frame 110 and may be free to bias toward the unflexed, neutral position. As the second panel 113 is opened, the flexed portion of the drip cover 102 may guide and lead further flexure of the drip cover 102 as its length is gradually received between the first and second panels 112, 113. Then, as the second panel 113 is closed again, the second longitudinal end 174 may gradually extend out from between the panels 112, 113, thereby allowing biased recovery back toward the neutral position. This pattern of resilient flexure and recovery may occur over the lifetime of the drip cover 102 as the second panel 113 is opened and closed, all the while covering the gap 130, and without impeding sliding movement of the second panel 113.

The drip cover 102 may be manufactured in a number of ways without departing from the scope of the present disclosure. For example, as shown in FIG. 5, the drip cover 102 may be formed using an extruder 201. The strip 166, the joint 176, and the strip 160 may be integrally attached as they are extruded along an extrusion axis (i.e., the longitudinal axis 126). Next, the first longitudinal end 172 may be formed at the bias angle 175. For example, as represented in FIG. 5, the end 172 may be formed via a cutting tool 203 to cut the end 172 at the bias angle 175. Subsequently, the adhesive 162 may be applied to the strip 160 as shown in FIG. 2. Next, the drip cover 102 may be conveniently attached to the panel 113 via the adhesive 162.

Accordingly, the drip cover 102 and its method of manufacture and assembly provide a number of advantages. The drip cover 102 may provide effective and robust protection against water intrusion. The drip cover 102 is unlikely to impede movement of the panel 113 and/or increase operating force for moving the panel 113. The drip cover 102 may also be manufactured efficiently and installed conveniently on the fenestration unit.

Furthermore, the following examples are provided:

In an example, a drip cover for a fenestration unit is provided, wherein the fenestration unit includes a frame and a slideable panel that is supported for sliding movement within the frame and relative to a surface of the fenestration unit. A gap is defined between the slideable panel and the frame. The drip cover includes a mounting member configured to attach to the slideable panel. The drip cover also includes an overhang that projects from the mounting member and that is configured to cover over the gap when the mounting member is attached to the slideable panel. The overhang is supported for resilient flexure relative to the mounting member between a neutral position and a flexed position. The overhang is resiliently biased toward the neutral position. The overhang, when the mounting member is attached to the slideable panel, is configured to contact the surface, thereby resiliently flexing the overhang between the neutral position and the flexed position, as the slideable panel slides relative to the surface.

In an option, the mounting member includes a strip configured to layer over a substantially vertical surface of the slideable panel. Also, the overhang projects away and in a downward direction from the strip. Moreover, the overhang is supported for rotational resilient flexure relative to the mounting member between the neutral position and the flexed position to change an angle defined between the overhang and the strip.

In an additional option, the mounting member includes an adhesive for attaching to the fenestration unit.

In an additional or alternative option, the drip cover further includes a pivotable joint that couples the overhang to the mounting member. The pivotable joint rotatably supports the overhang for resilient flexure relative to the mounting member between the neutral position and the flexed position.

In an additional option, the pivotable joint is integrally attached to the mounting member and the overhang.

Moreover, in an additional option, the pivotable joint is more flexible than the mounting member and the overhang.

Furthermore, in an additional option, the mounting member and the overhang include a first material, and the pivotable joint includes a second material, wherein the second material has higher material elasticity than the first material.

In an additional or alternative option, the overhang is elongate and extends along a longitudinal axis. The mounting member is configured to attach to the slideable panel with the longitudinal axis extending along a direction of sliding movement of the slideable panel relative to the surface. A horizontal transverse axis is defined substantially normal to the longitudinal axis. The overhang includes a first longitudinal end and a second longitudinal end that are spaced apart along the longitudinal axis. At least one of the first longitudinal end and the second longitudinal end is disposed at a bias angle relative to the horizontal transverse axis.

In an additional or alternative option, the overhang is cantilevered on the mounting member at a first edge of the overhang. The overhang includes a second edge that is spaced away from the mounting portion, wherein the second edge is tapered.

In still a further additional or alternative option, the mounting member includes a first strip, wherein the overhang includes a second strip. The drip cover further includes a resiliently flexible joint that rotatably couples respective edges of the first strip and the second strip. The joint is more flexible than the first strip and the second strip.

In an additional example, a method of manufacturing a drip cover for a fenestration unit is disclosed. The fenestration unit includes a frame and a slideable panel that is supported for sliding movement within the frame and relative to a surface of the fenestration unit. A gap is defined between the slideable panel and the frame. The method includes forming a mounting member configured to attach to the slideable panel. The method also includes forming an overhang that projects from the mounting member and that is configured to cover over the gap when the mounting member is attached to the slideable panel. The overhang is supported for resilient flexure relative to the mounting member between a neutral position and a flexed position. The overhang is resiliently biased toward the neutral position. The overhang, when the mounting member is attached to the slideable panel, is configured to contact the surface, thereby resiliently flexing the overhang between the neutral position and the flexed position, as the slideable panel slides relative to the surface.

In an additional option, forming the mounting member includes forming a strip configured to layer over a substantially vertical surface of the slideable panel. Also, forming the overhang includes forming the overhang to project away and in a downward direction from the strip. Moreover, forming the overhang includes supporting the overhang for rotational resilient flexure relative to the mounting member between the neutral position and the flexed position to change an angle defined between the overhang and the strip.

In an additional or alternative option, the method further includes providing the mounting member with an adhesive, wherein the adhesive is configured for attaching to the fenestration unit.

In an additional or alternative option, the method further includes forming a pivotable joint that couples the overhang to the mounting member. The pivotable joint rotatably supports the overhang for resilient flexure relative to the mounting member between the neutral position and the flexed position.

In an additional option, forming the pivotable joint includes integrally attaching the mounting member and the overhang.

In an additional option, the pivotable joint is more flexible than the mounting member and the overhang.

Moreover, in an additional option forming the mounting member, forming the overhang, and forming the pivotable joint includes co-extruding the mounting member, the overhang, and the pivotable joint. The mounting member and the overhang are extruded from a first material, wherein the pivotable joint is extruded from a second material, and wherein the second material has higher material elasticity than the first material.

In an additional or alternative option, forming the overhang includes forming the overhang to be elongate and to extend along a longitudinal axis, the mounting member configured to attach to the slideable panel with the longitudinal axis extending along a direction of sliding movement of the slideable panel relative to the surface. A horizontal transverse axis is defined substantially normal to the longitudinal axis. Forming the overhang includes forming the overhang to include a first longitudinal end and a second longitudinal end that are spaced apart along the longitudinal axis. The method also includes forming at least one of the first longitudinal end and the second longitudinal end to be disposed at a bias angle relative to the horizontal transverse axis.

In a further additional or alternative option, forming the overhang includes forming the overhang to be cantilevered on the mounting member at a first edge of the overhang. The overhang includes a second edge that is spaced away from the mounting portion, wherein the second edge is tapered.

In an additional example, a fenestration unit is disclosed that includes a frame and a panel supported for sliding movement within the frame relative to an engagement surface of the fenestration unit. A gap is defined between the panel and the frame. The fenestration unit further includes a drip cover that includes a mounting member that is attached to the panel and that includes an overhang that projects from the mounting member to cover over the gap. The drip cover includes a resiliently flexible pivot joint that attaches the overhang to the mounting member and that supports rotation of the overhang relative to the mounting member between a neutral position and a flexed position. The overhang is resiliently biased toward the neutral position. The overhang is configured to engage the engagement surface of the fenestration unit, thereby resiliently flexing the overhang between the neutral position and the flexed position, as the panel slides relative to the engagement surface of the fenestration unit.

In yet another additional example, a fenestration unit is disclosed that includes a frame and a panel supported for sliding movement within the frame relative to an engagement surface of the fenestration unit. A gap is defined between the panel and the frame. The fenestration unit further includes a drip cover that includes a frame and a slideable panel that is supported for sliding movement within the frame and relative to a surface of the fenestration unit. The gap is defined between the slideable panel and the frame. The drip cover further comprises a mounting member configured to attach to the slideable panel. The drip cover still further comprises an overhang that projects from the mounting member and configured to cover over the gap when the mounting member is attached to the slideable panel. The overhang is supported for resilient flexure relative to the mounting member between a neutral position and a flexed position, the overhang being resiliently biased toward the neutral position. The overhang, when the mounting member is attached to the slideable panel, is configured to contact the surface, thereby resiliently flexing the overhang between the neutral position and the flexed position, as the slideable panel slides relative to the surface.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It is understood that various changes may be made in the function and arrangement of elements described in an exemplary embodiment without departing from the scope of the present disclosure as set forth in the appended claims.

What is claimed is:

1. A drip cover for a fenestration unit, which includes a frame and a slideable panel that is supported for sliding movement within the frame and relative to a surface of the fenestration unit, a gap defined between the slideable panel and the frame, the drip cover comprising:
a mounting member configured to attach to the slideable panel;
an overhang that projects from the mounting member and configured to cover over the gap when the mounting member is attached to the slideable panel, the overhang supported for resilient flexure relative to the mounting member between a neutral position and a flexed position, the overhang being resiliently biased toward the neutral position; and
the overhang, when the mounting member is attached to the slideable panel, configured to contact the surface, thereby resiliently flexing the overhang between the neutral position and the flexed position, as the slideable panel slides relative to the surface.

2. The drip cover of claim 1, wherein the mounting member includes a strip configured to layer over a substantially vertical surface of the slideable panel;
wherein the overhang projects away and in a downward direction from the strip; and
wherein the overhang is supported for rotational resilient flexure relative to the mounting member between the neutral position and the flexed position to change an angle defined between the overhang and the strip.

3. The drip cover of claim 1, wherein the mounting member includes an adhesive for attaching to the fenestration unit.

4. The drip cover of claim 1, further comprising a pivotable joint that couples the overhang to the mounting member, the pivotable joint rotatably supporting the overhang for resilient flexure relative to the mounting member between the neutral position and the flexed position.

5. The drip cover of claim 4, wherein the pivotable joint is integrally attached to the mounting member and the overhang.

6. The drip cover of claim 5, wherein the pivotable joint is more flexible than the mounting member and the overhang.

7. The drip cover of claim 6, wherein the mounting member and the overhang include a first material, and wherein the pivotable joint includes a second material, the second material having higher material elasticity than the first material.

8. The drip cover of claim 1, wherein the overhang is elongate and extends along a longitudinal axis, the mounting member configured to attach to the slideable panel with the longitudinal axis extending along a direction of sliding movement of the slideable panel relative to the surface, a horizontal transverse axis defined substantially normal to the longitudinal axis;
wherein the overhang includes a first longitudinal end and a second longitudinal end that are spaced apart along the longitudinal axis; and
wherein at least one of the first longitudinal end and the second longitudinal end is disposed at a bias angle relative to the horizontal transverse axis.

9. The drip cover of claim 1, wherein the overhang is cantilevered on the mounting member at a first edge of the overhang, the overhang including a second edge that is spaced away from the mounting portion, wherein the second edge is tapered.

10. The drip cover of claim 1, wherein the mounting member includes a first strip, wherein the overhang includes a second strip;
the drip cover further comprising a resiliently flexible joint that rotatably couples respective edges of the first strip and the second strip; and
the joint being more flexible than the first strip and the second strip.

11. A method of manufacturing a drip cover for a fenestration unit, which includes a frame and a slideable panel that is supported for sliding movement within the frame and relative to a surface of the fenestration unit, a gap defined between the slideable panel and the frame, the method comprising:
forming a mounting member configured to attach to the slideable panel;
forming an overhang that projects from the mounting member and that is configured to cover over the gap when the mounting member is attached to the slideable panel, the overhang supported for resilient flexure relative to the mounting member between a neutral position and a flexed position, the overhang being resiliently biased toward the neutral position; and
the overhang, when the mounting member is attached to the slideable panel, configured to contact the surface, thereby resiliently flexing the overhang between the neutral position and the flexed position, as the slideable panel slides relative to the surface.

12. The method of claim 11, wherein forming the mounting member includes forming a strip configured to layer over a substantially vertical surface of the slideable panel;
wherein forming the overhang includes forming the overhang to project away and in a downward direction from the strip; and
wherein forming the overhang includes supporting the overhang for rotational resilient flexure relative to the mounting member between the neutral position and the flexed position to change an angle defined between the overhang and the strip.

13. The method of claim 11, further including providing the mounting member with an adhesive, the adhesive configured for attaching to the fenestration unit.

14. The method of claim 11, further comprising forming a pivotable joint that couples the overhang to the mounting member, the pivotable joint rotatably supporting the overhang for resilient flexure relative to the mounting member between the neutral position and the flexed position.

15. The method of claim 14, wherein forming the pivotable joint includes integrally attaching the mounting member and the overhang.

16. The method of claim 15, wherein the pivotable joint is more flexible than the mounting member and the overhang.

17. The method of claim 16, wherein forming the mounting member, forming the overhang, and forming the pivotable joint includes co-extruding the mounting member, the overhang, and the pivotable joint;
wherein the mounting member and the overhang are extruded from a first material, and wherein the pivotable joint is extruded from a second material, the second material having higher material elasticity than the first material.

18. The method of claim 11, wherein forming the overhang includes forming the overhang to be elongate and to extend along a longitudinal axis, the mounting member configured to attach to the slideable panel with the longitudinal axis extending along a direction of sliding movement of the slideable panel relative to the surface, a horizontal transverse axis defined substantially normal to the longitudinal axis;
wherein forming the overhang includes forming the overhang to include a first longitudinal end and a second longitudinal end that are spaced apart along the longitudinal axis; and
further comprising forming at least one of the first longitudinal end and the second longitudinal end to be disposed at a bias angle relative to the horizontal transverse axis.

19. The method of claim 11, wherein forming the overhang includes forming the overhang to be cantilevered on the mounting member at a first edge of the overhang, the overhang including a second edge that is spaced away from the mounting portion, wherein the second edge is tapered.

20. A fenestration unit comprising:
a frame;
a panel supported for sliding movement within the frame relative to an engagement surface of the fenestration unit, a gap defined between the panel and the frame;
a drip cover that includes a mounting member that is attached to the panel and that includes an overhang that projects from the mounting member to cover over the gap, the drip cover including a resiliently flexible pivot joint that attaches the overhang to the mounting member and that supports rotation of the overhang relative to the mounting member between a neutral position and a flexed position, the overhang being resiliently biased toward the neutral position; and
the overhang configured to engage the engagement surface of the fenestration unit, thereby resiliently flexing the overhang between the neutral position and the flexed position, as the panel slides relative to the engagement surface of the fenestration unit.
